(19) United States
(12) Patent Application Publication
(10) Pub. No.: US 2021/0080229 A1
(43) Pub. Date: Mar. 18, 2021

(54) BALLISTIC PANEL SYSTEM

(71) Applicant: Dillard Fisher, Chicago, IL (US)

(72) Inventor: Dillard Fisher, Chicago, IL (US)

(21) Appl. No.: 17/022,765

(22) Filed: Sep. 16, 2020

Related U.S. Application Data
(60) Provisional application No. 62/901,419, filed on Sep. 17, 2019.

(51) Int. Cl. F41H 5/013; F41H 5/04; F41H 5/14; B32B 3/02; B32B 5/18; B32B 27/30; B32B 27/34; B32B 27/06; B32B 9/00

(52) U.S. Cl. CPC F41H 5/013; F41H 5/0435; F41H 5/14; B32B 3/02; B32B 2571/02; B32B 27/30; B32B 27/34; B32B 27/065; B32B 9/005; B32B 5/18

(57) ABSTRACT

A ballistic panel system is disclosed and claimed. In particular, the ballistic panel system includes a plurality of panels, each of which includes a frame comprises of a plurality of vertical and horizontal beams connected together. An armor layer is disposed over the frame; the armor layer could be ceramic armor plates, graphene, Kevlar, or some other ballistic material. The ballistic panel system is intended for use in schools and other locations where hostile actors are known to operate.

### CROSS REFERENCE TO RELATED APPLICATIONS

The present disclosure claims priority to U.S. Provisional Pat. App. No. 62/901,419, filed on Sep. 17, 2019, which is hereby incorporated by reference in the entirety.

### FIELD OF THE DISCLOSURE

The present invention generally relates to a ballistic panel system and more particularly still, this invention relates to a ballistic panel system that can be stored in an unobtrusive manner and quickly deployed when needed to provide shelter for persons when an active shooter is present.

### DESCRIPTION OF BACKGROUND

The United States has the most school shootings in the world, where a school shooting is defined as an attack at an educational institution, such as a primary school, a secondary school, or a university. A partial listing of school shootings from 2019 in the United States includes Savannah, Ga. (1 shot), Highlands Ranch, Colo. (1 dead, 8 shot), Charlotte, N.C. (2 dead, 4 shot), Texas City, Tex. (3 shot), DeKalb County, Ga. (10 shot), and Columbus, Miss. (1 shot). School shootings are not a new issue in the United States, with records going back all the way to 1840. In addition, school shootings are not unique to the United States; numerous countries, including countries with complete gun bans, have experienced school shootings.

At least within the United States, political concerns make the likelihood of comprehensive gun reform unlikely. However, a number of solutions have been attempted to protect children and teachers at schools.

First, many schools now implement active shooter drills and train students and staff on what to do during such events. In particular, it is common to instruct the teacher to lock the classroom door, turn out the lights, and gather the students into an area of the classroom that cannot be seen from outside of the classroom with the door locked while keeping the students low and quiet.

In addition, certain schools now use ballistic blankets, such as those made by Armor Express. For example, Armor Express makes blankets that can be purchased with dimensions of 4′×8′, and which are constructed of Aramid fiber, which is generally considered equivalent to NIJ Level IIIA body armor; i.e., capable of stopping most 0.357 0.44 Magnum rounds. However, ballistic blankets are not capable of stopping rounds fired from common assault rifles, such as an AR-15 or AK 47, and unfortunately, assault rifles are now commonly used in school shootings. In use the ballistic blankets are draped over windows, door frames, and potentially, students and teachers, with the hopes of shielding persons from harm.

In addition, certain parents have purchased ballistic backpacks or ballistic backpack inserts for their children. Such a device provides a small surface that a child can use to shield themselves from harm. However, ballistic backpacks are generally significantly heavier than other backpacks, and also cannot typically stop a round fired from an assault rifle. Similarly, ballistic backpack inserts typically also cannot stop a round fired from an assault rifle. In addition, a ballistic backpack provides a limited amount of cover; when worn normally, the backpack will not shield the wearer's head, front, or legs.

Accordingly, a need exists for shelter that can be deployed quickly while providing protection from rounds that are fired from an assault rifle.

### OBJECTS OF THE DISCLOSED SYSTEM, METHOD, AND APPARATUS

Accordingly, it is an object of this disclosure to provide a ballistic panel system for providing shelter.

Another object of this disclosure is to provide a ballistic panel system that can be installed unobtrusively at a site.

Another object of this disclosure is to provide a ballistic panel system that can be rapidly deployed once installed.

Another object of this disclosure is to provide a ballistic panel system capable of stopping a round fired from an assault rifle.

Another object of this disclosure is to provide a ballistic panel system capable of providing protection comparable to Level IV body armor.

Other advantages of this disclosure will be clear to a person of ordinary skill in the art. It should be understood, however, that a system, an apparatus or a method could practice the disclosure while not achieving all of the enumerated advantages, and that the protected disclosure is defined by the claims.

### SUMMARY OF THE DISCLOSURE

Pursuant to the various embodiments, the present disclosure comprises a ballistic panel system. In particular, the ballistic panel system comprises a plurality of panels, wherein each of the panels includes a frame. The frame includes first and second vertical exterior beams. Each of the vertical exterior beams includes a plurality of hinges that are adapted to couple with the hinges of vertical exterior beams from other panels. The frame also includes upper and lower horizontal beams that are coupled to the vertical exterior beams. In addition, an armor layer is draped over at least one side of the frame. The armor layer can comprise, for example, ceramic armor plates, graphene, Kevlar, Aramid fiber, or other ballistic materials.

In an additional embodiment of the disclosure, the frame of the ballistic panel further comprises at least one interior vertical beam disposed between the first exterior vertical beam and the second exterior vertical beam. The at least one interior vertical beam is coupled to the upper and lower horizontal beams.

In another embodiment of the disclosure, the ballistic panel further comprises a plurality of castors coupled to the bottom of the lower horizontal beam. The castors can be coupled to the frame in a number of ways; for example, they can be disposed in a single row and coupled to the lower horizontal beam by a stem with a screw pattern. Alternatively, the castors can comprise castor assemblies, with each assembly including a lateral beam, a pair of castors, and an attachment pin.

### BRIEF DESCRIPTION OF THE DRAWINGS

Although the characteristic features of this disclosure will be particularly pointed out in the claims, the disclosure itself, and the manner in which it may be made and used, may be better understood by referring to the following description taken in connection with the accompanying drawings forming a part hereof, wherein like reference numerals refer to like parts throughout the several views and in which:

FIG. 1 is a front view of a ballistic panel constructed in accordance with this disclosure.

FIG. 2 is a front perspective view of a horizontal beam for use with a ballistic panel constructed in accordance with this disclosure.

FIG. 3 is an alternative front perspective view of a horizontal beam for use with a ballistic panel constructed in accordance with this disclosure.

FIG. 4 is a front perspective view of an interior vertical beam for use with a ballistic panel constructed in accordance with this disclosure.

FIG. 5 is a side perspective view of a caster for use with a ballistic panel constructed in accordance with this disclosure.

FIG. 6 is a top view of a ballistic panel constructed in accordance with this disclosure.

FIG. 7 is a top view of a classroom and hallway with a ballistic panel system constructed in accordance with this disclosure being disposed therein.

FIG. 8 is a side view of a ballistic panel system constructed in accordance with this disclosure and in a stored configuration.

FIG. 9 is a front view of ballistic panel with an alternative caster configuration constructed in accordance with this disclosure.

FIG. 10 is a side perspective view of an alternative caster configuration for use with a ballistic panel constructed in accordance with this disclosure.

A person of ordinary skills in the art will appreciate that elements of the figures above are illustrated for simplicity and clarity, and are not necessarily drawn to scale. The dimensions of some elements in the figures may have been exaggerated relative to other elements to help understanding of the present teachings. Furthermore, a particular order in which certain elements, parts, components, modules, steps, actions, events and/or processes are described or illustrated may not be actually required. A person of ordinary skills in the art will appreciate that, for the purpose of simplicity and clarity of illustration, some commonly known and well-understood elements that are useful and/or necessary in a commercially feasible embodiment may not be depicted in order to provide a clear view of various embodiments in accordance with the present teachings.

### DETAILED DESCRIPTION

Turning to the Figures and to FIG. 1 in particular, a panel 10 for use with a ballistic panel system constructed in accordance with this disclose is illustrated. The panel 10 comprises a metal frame that includes a first exterior vertical beam 12a and a second exterior vertical beam 12b. The panel 10 further comprises a first horizontal beam 14a and a second horizontal beam 14b. In addition, the panel 10 includes one or more interior vertical beams 16.

The frame and its constituent beams can be constructed of a variety of metals, including, for example, aluminum, steel, titanium, or a variety of alloys. In addition, other materials could be used; for example, graphene could be used to construct an extremely durable and lightweight frame.

Each of the exterior vertical beams 12a and 12b include one or more hinges 20. Each of the hinges can be a fairly simple butt hinge, or a single large piano hinge could be used.

In addition, a number of casters 24 are mounted to a lower surface of the second horizontal beam 14b. Generally, the casters 24 will be swivel casters; i.e., castors that can rotate in all directions, which will aid the panels to swivel into deployment as explained below. The casters can be mounted to the lower surface of the second horizontal beam 14b using a caster stem that can snap into place in an aperture 29 formed in the lower surface of the second horizontal beam 14b. In particular, the apertures 29 are clearly depicted in FIG. 2, where the second horizontal beam 14b is depicted as inverted; i.e., the lower surface is drawn facing upwards. In addition, the second horizontal beam 14b includes a number of bolt holes 31. Each of the bolt holes is configured to accept a bolt, which can be held in place using a nut and potentially a lock washer.

FIG. 3 illustrates the other side of the horizontal beams 14a and 14b. In particular, as oriented, FIG. 3 depicts the and front of the lower horizontal beam 14b and the bottom and front of the upper horizontal beam 14a. As illustrated each of the horizontal beams 14a and 14b also includes a plurality of apertures 33, such as four apertures 33, which can be substantially rectangular in form. The apertures 33 are sized to accept an end of the interior vertical beams 16. In particular, a tapered end of the interior vertical beam 16 is adapted to fit within the aperture 33, and held in place by a bolt (not shown) using a bolt hole 31.

A vertical interior beam 16 is depicted in FIG. 4. The vertical interior beam 16 includes a center portion 16a and a pair of tapered ends 16b. As explained above, the tapered ends are adapted to mate with the apertures 33 formed in the horizontal beams 14a and 14b.

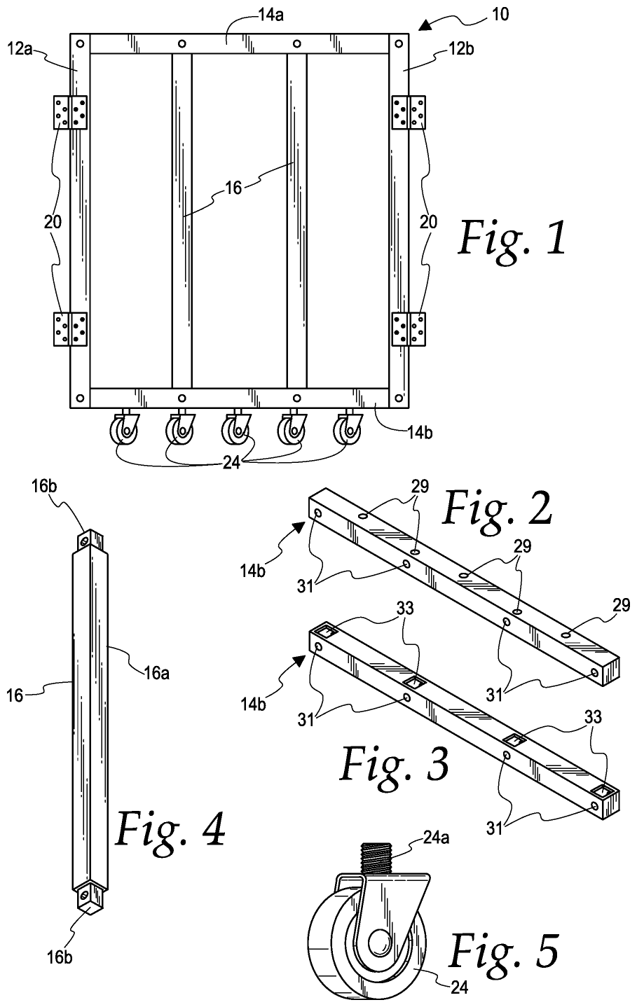

Turning to FIG. 5, a simple swivel caster 24 is depicted. A caster stem 24a is adapted to mate with an aperture 29 formed in the lower surface of the lower horizontal beam 14b. In particular, the caster stem 24a can be adapted to snap into the aperture 29, or, alternatively, can be secured using a number of screws (not shown).

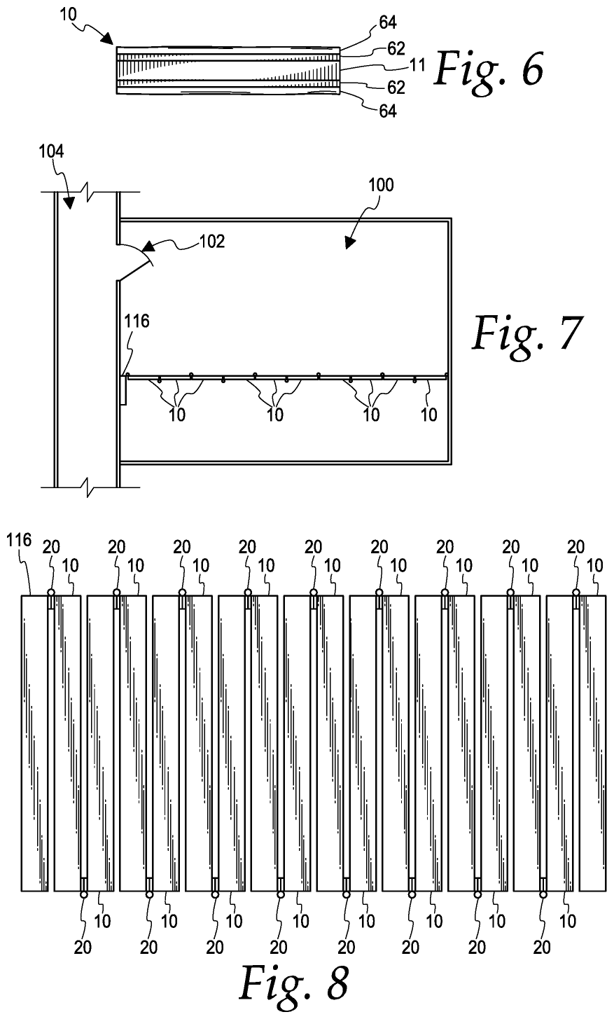

Turning to FIG. 6, a profile view of a single panel 10 is depicted without any of the hinges being shown. As can be seen, the panel 10 is constructed in a layered fashion, with the frame 11 being shown in the center. Immediately adjacent to the frame 11 is an armor layer 62. The armor layer 62 is designed to provide protection and specifically to provide protection from bullets, up to and including rounds fired from assault rifles. The armor layer 62 can comprise a variety of materials, including ceramic armor plates, graphene, Kevlar, Aramid fiber, or other protective materials as are known in the art. Adjacent to and outside of the armor layer 62 is an optional padded layer 64. The padded layer 64 is intended to serve two functions. First, the padded layer is adapted to preserve the comfort of those that shelter behind it. Second, the padded layer will allow for decorative or aesthetic markings to be displayed; for example, a school logo could be printed on the exterior of the panel system, so that when it is deployed, it will not be immediately apparent that it is a ballistic shelter. The padded layer 64 can comprise vinyl or nylon over foam or gel, or any other material or combination of materials that allows for padding.

Turning to FIG. 7, a top view of a classroom 100 with a fully deployed panel system is shown. As illustrated, the classroom 100 has an entryway 102 that opens to a hallway 104. The panel system is shown deployed in the lower portion of the classroom, and comprises a number of panels 10. The first panel 10 is coupled to a wall mount 116 using the hinge system shown in FIG. 1.

FIG. 8 depicts the disclosed panel system with all panels 10 stacked against the wall. In particular, a plurality of panels 10 are shown folded against a wall mount 116, with the hinges 20 clearly visible. To deploy the panel system, the outermost panel 10 is merely dragged toward the other wall of the area until all of the panels 10 are deployed. As the panels are pulled out, they will swivel into place on the aforementioned casters.

FIG. 9 depicts a ballistic panel 210 with an alternative caster configuration. The panel 210 comprises a metal frame that includes a first exterior vertical beam 12a and a second exterior vertical beam 12b. The construction of the vertical beams 12a and 12b are identical to the construction of the corresponding beams in the embodiment of FIG. 2. The panel 210 further comprises a first horizontal beam 214a and a second horizontal beam 214b. In addition, the panel 210 includes one or more interior vertical beams 16. The construction of the horizontal beams 214a and 214b and the interior vertical beams 16 can be identical to the construction of the corresponding elements in the embodiment of FIG. 2; i.e., horizontal beams 14a and 14b.

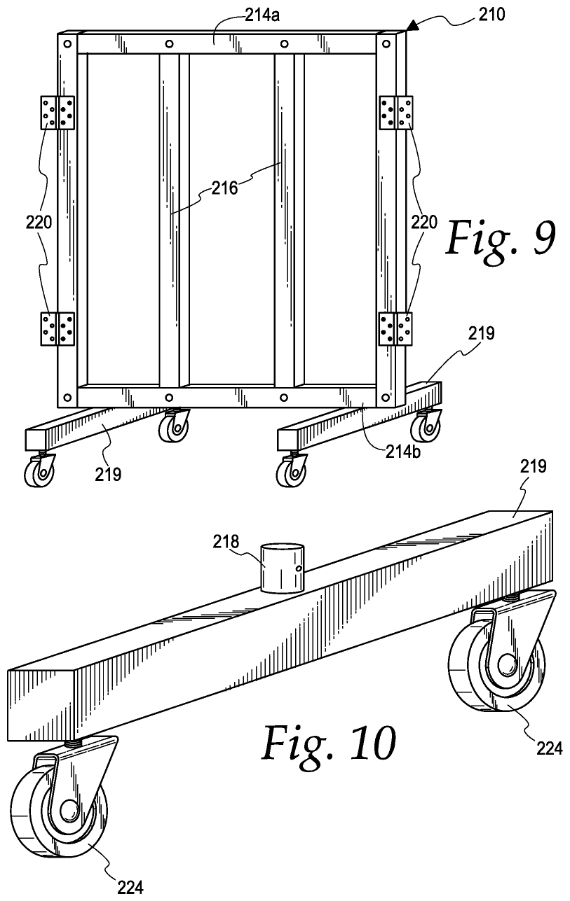

In addition, a pair of caster assemblies 262 are affixed to the bottom of the second horizontal beam 214b. The caster assembly 262 is best depicted in FIG. 10. Each caster assembly 262 comprises a lateral beam 219 which includes an attachment pin 218 located in approximately the center of the upper surface of the lateral beam 219. The attachment pin 218 is adapted to couple with an aperture in the bottom surface of the second horizontal beam 214b, whereby the attachment pin 218 can snap into an appropriate position within the aperture. Each of the caster assemblies further includes a pair of casters 224, with the casters 224 being disposed on opposite ends of the bottom surface of the lateral beam 219.

Obviously, many additional modifications and variations of the present disclosure are possible in light of the above teachings. Thus, it is to be understood that, within the scope of the appended claims, the disclosure may be practiced otherwise than is specifically described above

The foregoing description of the disclosure has been presented for purposes of illustration and description, and is not intended to be exhaustive or to limit the disclosure to the precise form disclosed. The description was selected to best explain the principles of the present teachings and practical application of these principles to enable others skilled in the art to best utilize the disclosure in various embodiments and various modifications as are suited to the particular use contemplated. It should be recognized that the words “a” or “an” are intended to include both the singular and the plural. Conversely, any reference to plural elements shall, where appropriate, include the singular.

It is intended that the scope of the disclosure not be limited by the specification, but be defined by the claims set forth below. In addition, although narrow claims may be presented below, it should be recognized that the scope of this invention is much broader than presented by the claim(s). It is intended that broader claims will be submitted in one or more applications that claim the benefit of priority from this application. Insofar as the description above and the accompanying drawings disclose additional subject matter that is not within the scope of the claim or claims below, the additional inventions are not dedicated to the public and the right to file one or more applications to claim such additional inventions is reserved.

What is claimed is:

1. A ballistic panel comprising:
a frame including a first vertical exterior beam and a second vertical exterior beam wherein each of the vertical exterior beams includes a plurality of hinges, wherein each hinge is adapted to couple with a hinge of a different ballistic panel;
the frame further including an upper horizontal beam disposed on a top side of the first vertical exterior beam and the second vertical exterior beam;
the frame further including a lower horizontal beam disposed on a bottom side of the first vertical exterior beam and the second vertical exterior beam; and
an armor layer disposed over at least one side of said frame.

2. The ballistic panel of claim 1 further comprising at least one interior vertical beam disposed between the first vertical exterior beam and the second vertical exterior beam, the at least one interior vertical beam being coupled to the upper horizontal beam and the lower horizontal beam.

3. The ballistic panel of claim 1 further comprising a plurality of castors coupled to a bottom side of the lower horizontal beam.

4. The ballistic panel of claim 3 wherein the plurality of castors each include a stem with a screw portion and are coupled to the bottom side of the lower horizontal beam by the screw portion.

5. The ballistic panel of claim 3 wherein the plurality of castors comprise two or more castor assemblies, wherein each castor assembly comprises a lateral beam with a bottom side and two castors, wherein each of the two castors are disposed on opposite ends of the bottom side of the lateral beam.

6. The ballistic panel of claim 5 wherein each castor assembly further comprises an attachment pin disposed at approximately the center of an upper surface of the lateral beam.

7. The ballistic panel of claim 1 wherein the armor layer comprises a plurality of ceramic armor plates.

8. The ballistic panel of claim 7 wherein the armor layer further comprises a layer of Kevlar over the ceramic armor plates.
